(19) United States
(12) Patent Application Publication
(10) Pub. No.: US 2005/0254634 A1
(43) Pub. Date: Nov. 17, 2005

(54) Telephone having slot for receiving a removable memory card

(76) Inventor: Bruce W.H. Sun, Taipei (TW)

Correspondence Address: DENNISON, SCHULTZ, DOUGHERTY;& MACDONALD, Suite 105, 1727 King Street, Alexandria, VA, 22314, US

(21) Appl. No.: 11/036,382

(22) Filed: Jan. 18, 2005

(30) Foreign Application Priority Data
May 17, 2004 (TW) 093113906

(51) Int. Cl. H04M 11/00; H04M 1/00; H04M 9/00

(52) U.S. Cl. 379/93.24; 379/433.12; 379/433.01

(57) ABSTRACT

A telephone having a slot for receiving a removable memory card is provided. The telephone comprises an internal main controller. The memory card is a readable/writable memory card and is adapted to connect to a computer via an interface such as USB port, a RS232 port, or a network. Programs or data downloaded from the network or the computer can be stored in the memory card. After inserting the memory card into the receiving slot, the main controller is adapted to read and run, for example, the programs or data stored in the memory card to configure the telephone as a multifunctional one.

### BACKGROUND OF THE INVENTION

1. Field of the Invention

The present invention relates to telephone sets and more particularly to a telephone (or cellular phone) having a slot for receiving a removable memory card such that the functions of the telephone (or cellular phone) can be configured as a multifunctional one and be made more powerful by, for example, accessing contents of the memory card.

2. Description of Related Art

Nowadays, some types of conventional telephones having one or more functions including call answering, recording, and transfer are commercially available. However, the conventional telephones or cellular phones are not improved sufficiently to keep up with the technological advancements of computer and/or network as observed by the present inventor. Thus, the need for improvement still exists.

### SUMMARY OF THE INVENTION

It is an object of the present invention to provide a telephone having a slot for receiving a removable memory card in which the telephones have the advantages of being easily produced by manufacturers, being affordable by vast consumers, being easy in use, and being adapted to change and/or expand its existing functions. In use, a user may download a desired program via the Internet or select a desired program from CD. The selected program is then stored in the memory card via an interface (e.g., USB port, RS232 port, network side, or the like) of computer. After inserting the memory card into a telephone of the invention, the internal CPU or DSP of the telephone is adapted to read, activate, and perform the memory card such that the telephone can be configured as a telephone being capable of performing one of various functions as desired by user. Moreover, data such as call recording, dialing, input, transfer, incoming call signals, communication data, etc. created during the connection of the telephone and a user can be stored in the memory card. Next, remove the memory card and insert it into a memory card of a computer so that the computer can read contents of the memory card via an interface thereof. Next, a program will perform analysis, statistics, display, playing, storage, and printing about such contents, and use it. As an end, the functions of telephone can be made more powerful and the use of telephone can be more convenient.

One aspect of the present invention is to increase the functions of telephone and convenience of using the same. It is understood that the technologies of computer and the Internet have made great progress in a very fast pace. Any program, sound, image, and data can be digitized for facilitating transfer. Telephones have been the most important communication device for a long time and are widely used in our daily life by users. Thus, it is desirable to utilize software and data stored in the computer or employ a computer as a tool for creating applications and data which are adapted to be utilized by a telephone by inserting a memory card into the computer. As such, the function of a telephone can be altered or enhanced by inserting a memory card having software into the telephone as desired by a user. Alternatively, it is possible of processing communication data by operating a telephone connected to the telephone line and the processed data is then stored in a computer for being further utilized thereafter. Still alternatively, the telephone may read data from the memory card so that the purposes of increasing the functions of telephone and convenience of using the same can be achieved.

Another aspect of the present invention is to provide a multifunctional telephone being adapted to use in one of various conditions and achieve one of a plurality of purposes. Thus, the telephone, having a slot for receiving a removable memory card of the present invention, comprises enabling a computer to operate one of actions including web downloading and reading data from a hard disk or CD for obtaining a desired program or data, inserting the memory card into a receiving slot of the telephone, controlling the memory card by a main controller for sending a program, audio-video (AV) information, or data from the memory card to the telephone, enabling a telephone user to read the same, alter the function of the telephone, or automatically store a program, AV information or data sent over the telephone line in the memory card, and allowing a user to utilize the same or load it into a computer for further applications.

A further aspect of the present invention to provide a telephone having a slot for receiving a removable memory card. The telephone comprises a receiving slot being adapted to removably receive a memory card and a removable memory card being adapted to either insert into the receiving slot or remove therefrom. The memory card has many different programs or data stored therein by operating a computer or any of other equivalent operations. Alternatively, the memory card is adapted to record call contents conveyed over a telephone line such that the telephone can be configured as a multifunctional one to be adapted to various conditions and purposes.

The above and other objects, features and advantages of the present invention will become apparent from the following detailed description taken with the accompanying drawings.

### BRIEF DESCRIPTION OF THE DRAWINGS

FIG. 1A is a side view of a telephone set having a receiving slot at one side according to a first configuration of telephone of the invention, where a memory card is to be inserted into the receiving slot;

FIG. 1B is a perspective view of a telephone set having a receiving slot at a forward end according to a second configuration of telephone of the invention, where a memory card is to be inserted into the receiving slot;

FIG. 1C is a bottom view of a telephone set having a receiving slot at a bottom according to a third configuration of telephone of the invention, where a memory card is to be inserted into the receiving slot;

FIG. 1D is a perspective view of a hands-free conference telephone having a concealed receiving slot at a forward end according to a fourth configuration of telephone of the invention, where a memory card is to be inserted into the receiving slot;

FIG. 2 is a block diagram of the constituent components of a telephone according to a first preferred embodiment of the invention;

FIG. 3 is a block diagram of the constituent components of a telephone according to a second preferred embodiment of the invention;

FIG. 4 is a block diagram of the constituent components of a telephone according to a third preferred embodiment of the invention;

FIG. 5 is a block diagram of the constituent components of a telephone according to a fourth preferred embodiment of the invention;

FIG. 6 is a block diagram of the constituent components of a telephone according to a fifth preferred embodiment of the invention;

FIG. 6A is a block diagram of the constituent components of a telephone according to a sixth preferred embodiment of the invention;

FIG. 6B is a block diagram of the constituent components of a telephone according to a seventh preferred embodiment of the invention;

FIG. 6C is a block diagram of the constituent components of a telephone according to an eighth preferred embodiment of the invention;

FIG. 7 is a block diagram of the constituent components of main controller according to a first preferred embodiment of main controller of the invention;

FIG. 8 is a block diagram of the constituent components of main controller according to a second preferred embodiment of main controller of the invention;

FIG. 9 is a block diagram of the constituent components of main controller according to a third preferred embodiment of main controller of the invention;

FIG. 10 is a block diagram of the constituent components of main controller according to a fourth preferred embodiment of main controller of the invention;

FIG. 11 is a flow chart illustrating processes of memory card insertion and programming according to the invention;

FIGS. 12A, 12B, and 12C are flow charts illustrating a process of call recording according to the invention;

FIG. 13 is a flow chart illustrating a process of information inquiry according to the invention; and

FIGS. 14A and 14B are flow charts illustrating a process of transfer according to the invention.

### DETAILED DESCRIPTION OF THE PREFERRED EMBODIMENTS

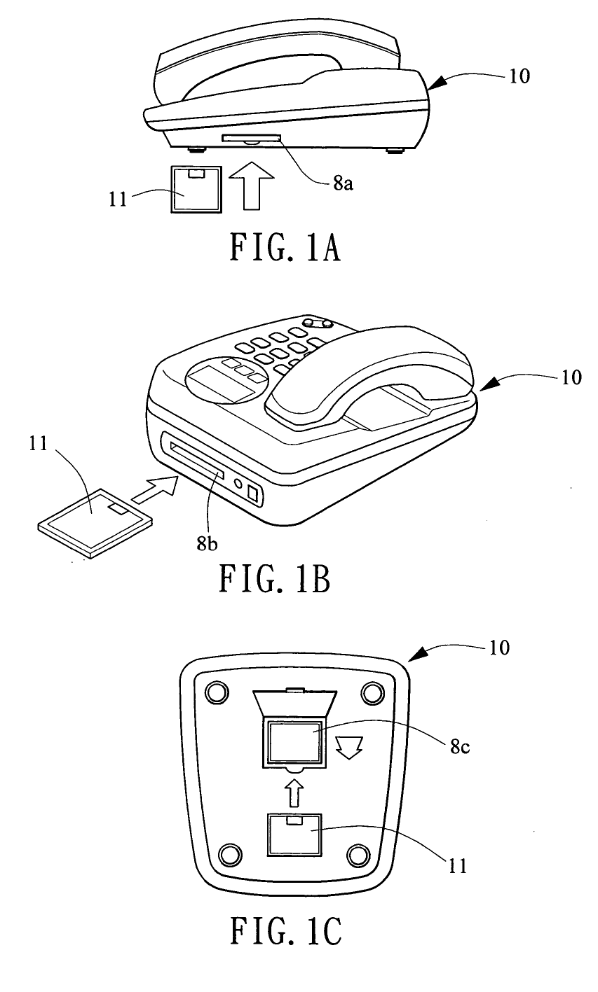

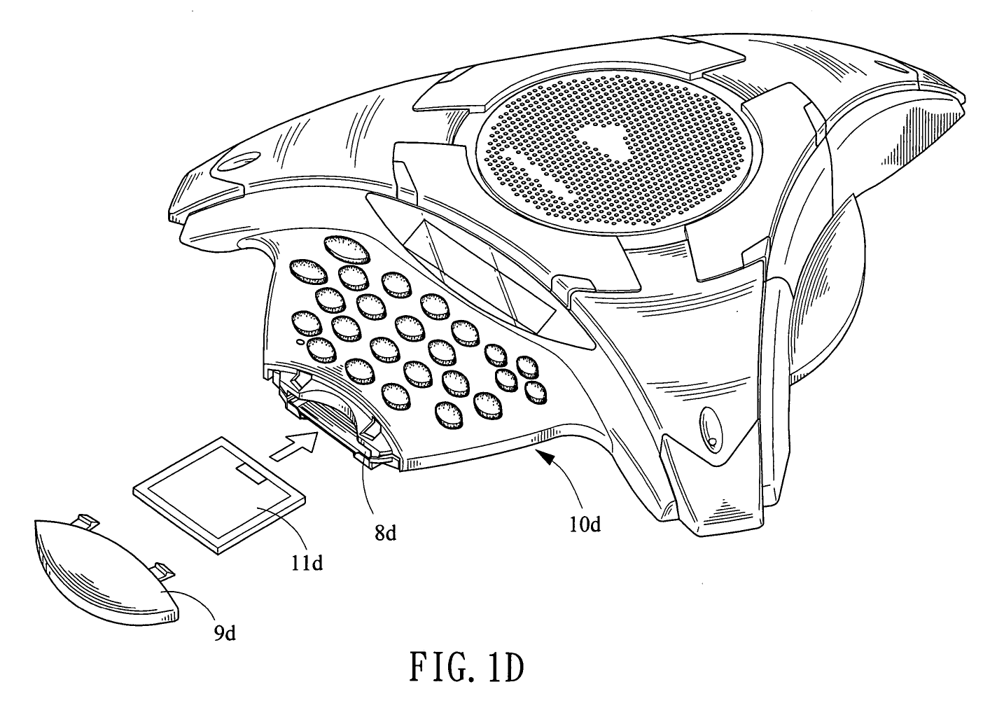

Referring to FIGS. 1A to 1D, four locations of receiving slot on a telephone set 10 are shown. In FIG. 1A, a receiving slot 8a is provided at either side of the telephone set 10. In FIG. 1B, a receiving slot 8b is provided at a forward end of the telephone set 10. In FIG. 1C, a receiving slot 8c is provided at a bottom of the telephone set 10. In FIG. 1D, a concealed receiving slot 8d is provided at a forward end of a hands-free conference telephone 10d in which the receiving slot 8d can be exposed by removing a cap 9d. In any of the above cases, a memory card 11 or 11d is adapted to insert into the receiving slot 8a, 8b, 8c, or 8d. The memory card 11 or 11d is implemented as a Compact Flash Card (CF), a Smart Media Card (SM), a Secure Digital Card (SD), a Memory Stick Card (MS), a MultiMedia Card (MMC), a Micro Drive Card, or any of other accessible media.

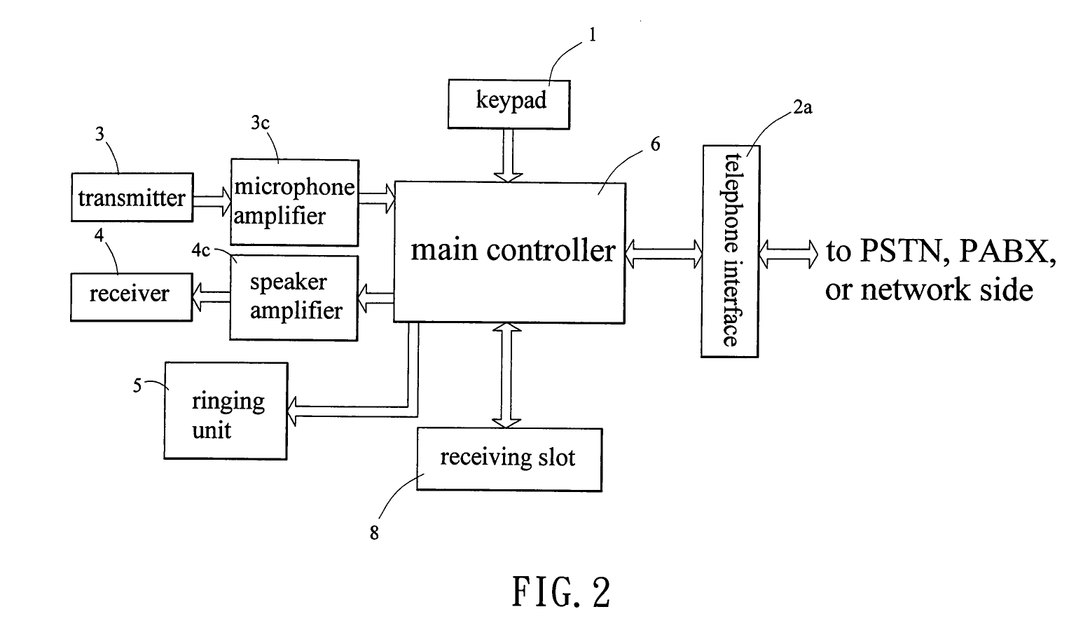

Referring to FIG. 2, there is shown a block diagram of the constituent components of a telephone according to a first preferred embodiment of the invention. The telephone comprises a keypad 1 for dialing or input commands or data; a main controller 6; a telephone interface 2a connected to a PSTN (Public Switched Telephone Network), PABX (Private Automatic Branch Exchange), or network side for sending analog or digital signal or VolP (Voice over IP) to the main controller 6 (note that the telephone interface 2a can be eliminated if the telephone is implemented as a cellular phone); a receiving slot 8 for permitting a memory card to insert into or remove therefrom; a transmitter 3 for receiving sound from a calling party, the transmitter 3 including a microphone amplifier 3c for amplifying sound prior to sending to the main controller 6 such that the main controller 6 may process the same and send either an analog or digital signal of the processed sound to the telephone interface 2a or a digital signal of the processed sound to a memory card plugged in the receiving slot 8, the transmitter 3 being implemented as a microphone of a handset, one or more microphones of a hands-free device of cellular phone, or a combination thereof; a receiver 4 including a coupled speaker amplifier 4c for receiving analog or digital signals from the network or telephone line or receiving amplified signals from the speaker amplifier 4c which receives analog signals converted from the main controller 6 in which the signals converted by the main controller 6 are digital data read from the memory card, the receiver 4 being implemented as a speaker of the handset, one or more speakers of a hands-free device of cellular phone, or a combination thereof; and a ringing unit 5 for ringing when an incoming call is received. The main controller 6 is adapted to detect signals, control, compress image and data, convert analog to digital or convert digital to analog, convert format, and perform I/O (input/output) with respect to all other components described above. Also, functions of the main controller 6 are preprogrammed before being delivered from the factory. Alternatively, one of a plurality of functions of the main controller 6 can be created by linking applications of the inserted memory card or replaced thereby.

By configuring as above, a user may insert a desired memory card into the receiving slot 8. Next, the main controller 6 functions to either store programs, images, sound, and data conveyed on the telephone line into the memory card or send programs, images, sound, and data loaded on the memory card to the telephone line such that the telephone can be configured as a multifunctional telephone for being adapted to different purposes and applications.

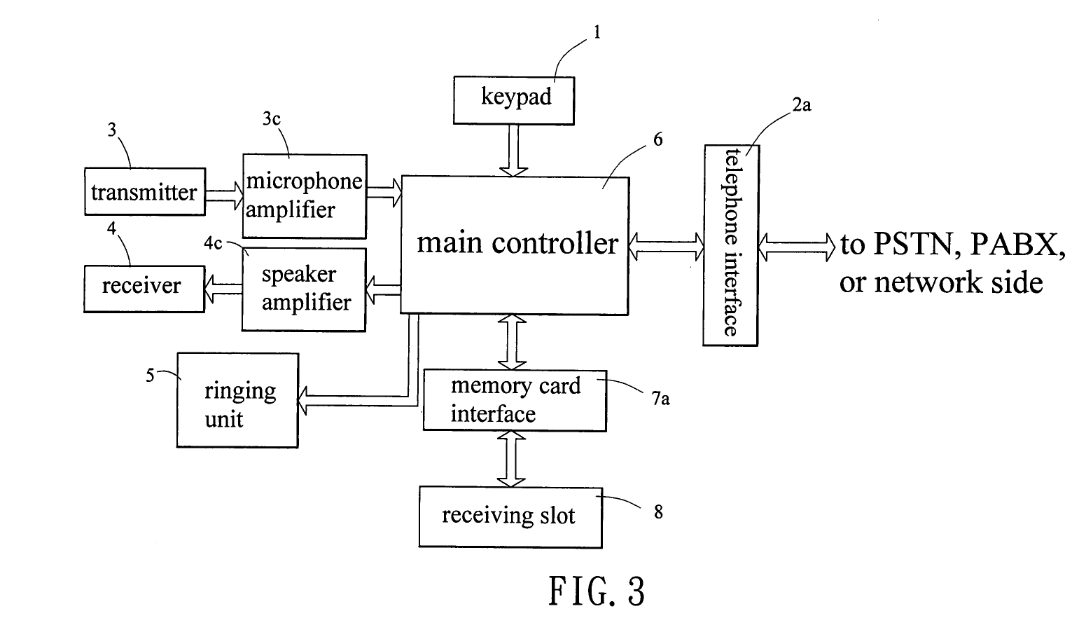

Referring to FIG. 3, there is shown a block diagram of the constituent components of a telephone according to a second preferred embodiment of the invention. The second preferred embodiment substantially has same structure as the first preferred embodiment. The differences between the first and the second preferred embodiments, i.e., the characteristics of the second preferred embodiment are detailed below. The memory card interface of the main controller 6 in the first preferred embodiment is removed to dispose outside the main controller 6. Specifically, the memory card interface 7a has one end connected to the main controller 6 and the other end connected to pins of one of a variety of memory cards such that data access can be facilitated.

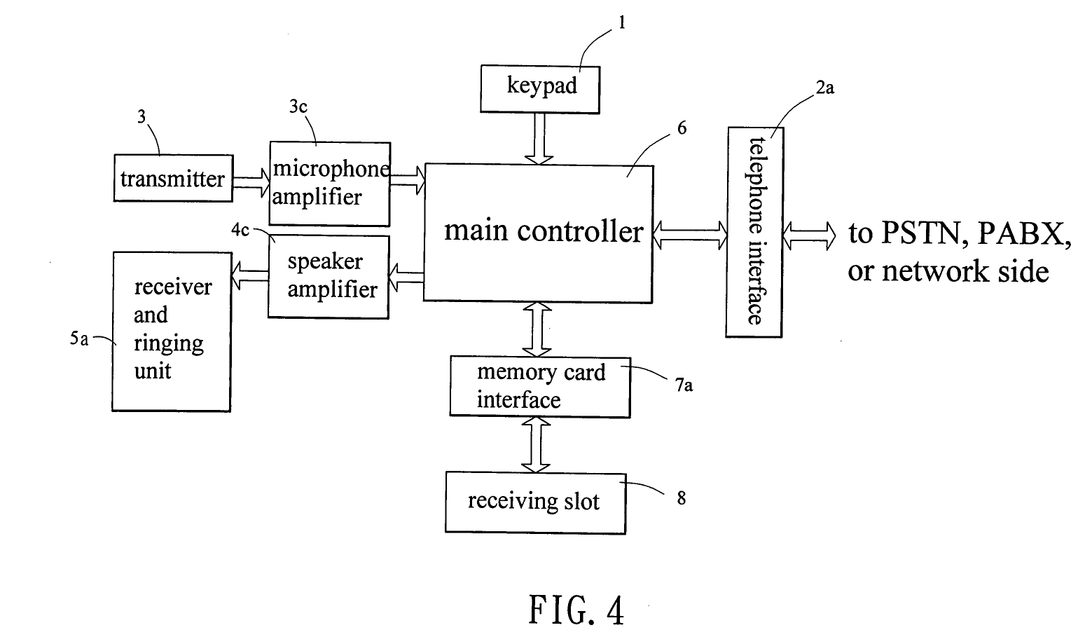

Referring to FIG. 4, there is shown a block diagram of the constituent components of a telephone according to a third preferred embodiment of the invention. The third preferred embodiment substantially has same structure as the first or second preferred embodiment. The characteristics of the third preferred embodiment are detailed below. The receiver and the ringing unit are combined as a unitary receiver and ringing unit 5a so that ringing can be generated by the receiver directly, thereby decreasing the number of the telephone components.

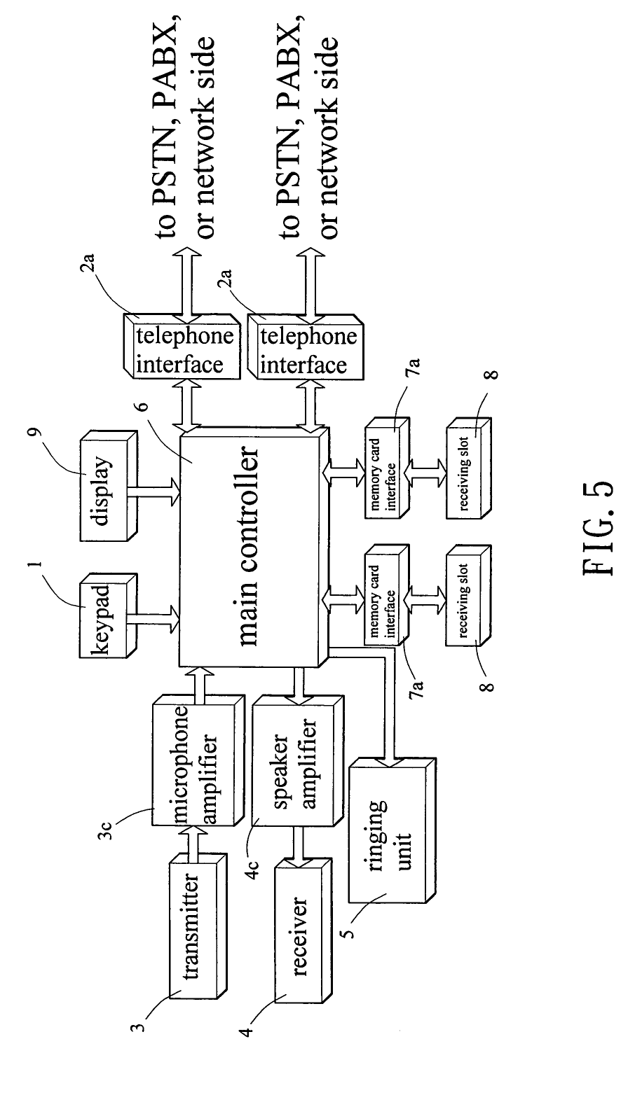

Referring to FIG. 5, there is shown a block diagram of the constituent components of a telephone according to a fourth preferred embodiment of the invention. The fourth preferred embodiment substantially has same structure as the second preferred embodiment shown in FIG. 3. The characteristics of the fourth preferred embodiment are detailed below. Two pairs of memory card interface 7a and receiving slot 8 and two telephone interfaces 2a are provided such that the telephone can be connected to two memory cards and two telephone lines at the same time and thus has the benefits of increased expansion capability and convenience. Moreover, a display 9 is provided and is connected to the main controller 6 so that images, data, messages, operating mode, and associated information can be sent from the main controller 6 to the display 9 for display for user inquiry or viewing.

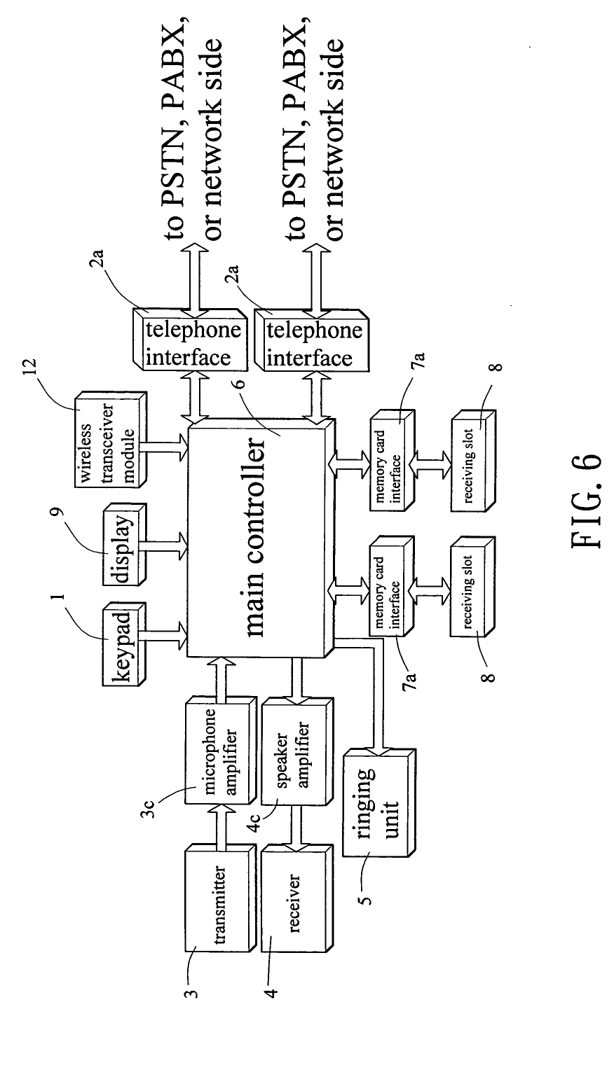

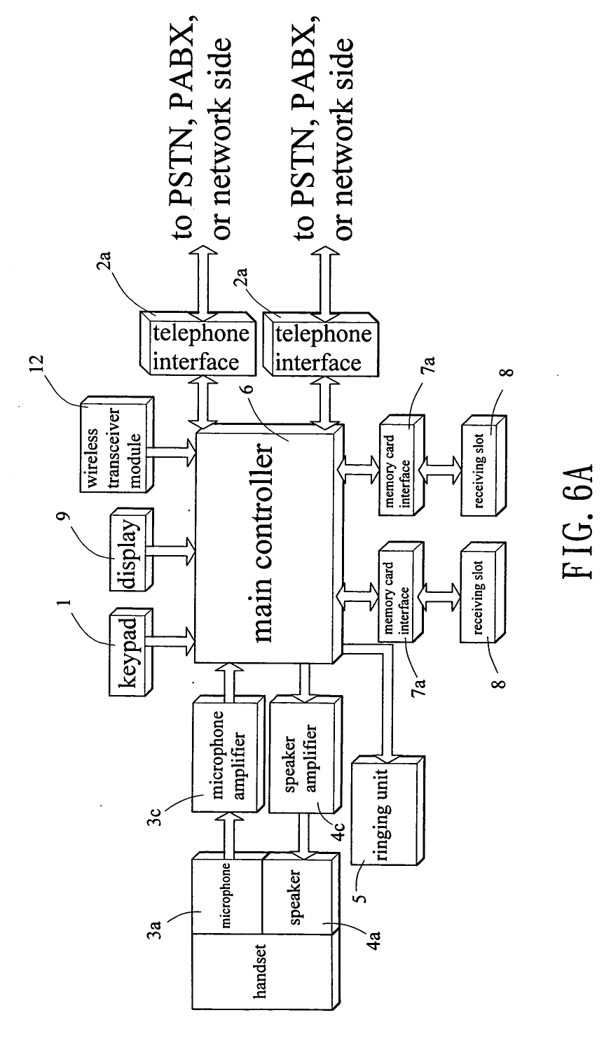

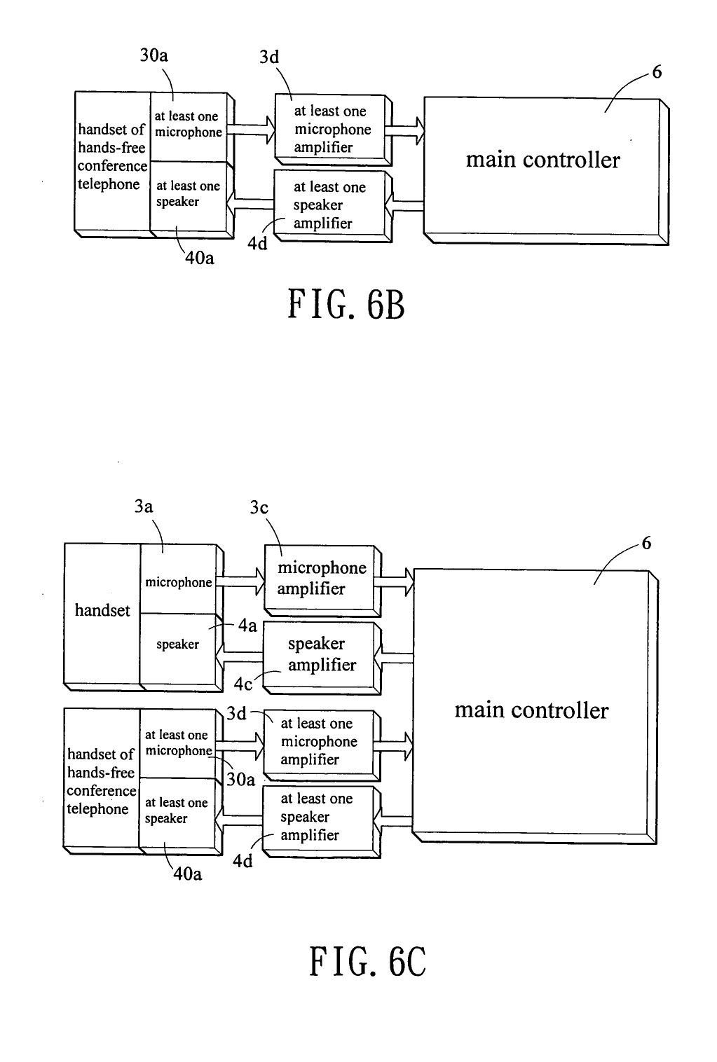

Referring to FIG. 6, there is shown a block diagram of the constituent components of a telephone according to a fifth preferred embodiment of the invention. The fifth preferred embodiment substantially has same structure as the fourth preferred embodiment. The differences between the fifth and the fourth preferred embodiments, i.e., the characteristics of the fifth preferred embodiment are detailed below. A wireless transceiver module 12 is further provided and is connected to the main controller 6 such that the main controller 6 is able to wirelessly communicate with the handset or Bluetooth of a cordless telephone, thereby increasing the number of applications.

Referring to FIG. 6A, there is shown a block diagram of the constituent components of a telephone according to a sixth preferred embodiment of the invention. The sixth preferred embodiment substantially has same structure as the fifth preferred embodiment. The differences between the sixth and the fifth preferred embodiments, i.e., the characteristics of the sixth preferred embodiment are detailed below. The transmitter 3 is a microphone 3a and the receiver 4 is a speaker 4a respectively. In the embodiment, the transmitter 3 is implemented as a microphone 3a of the handset and the receiver 4 is implemented as a speaker 4a thereof respectively.

Referring to FIG. 6B, there is shown a block diagram of the constituent components of a telephone according to a seventh preferred embodiment of the invention. The seventh preferred embodiment substantially has same structure as the fifth preferred embodiment. The characteristics of the seventh preferred embodiment are detailed below. The transmitter 3 is comprised of at least one microphone 30a and the receiver 4 is comprised of at least one speaker 40a respectively. In the embodiment, the transmitter 3 and the receiver 4 are formed as a unitary handset of hands-free conference telephone, i.e., the handset thereof comprised of at least one microphone 30a and at least one speaker 40a. In operation, a number of people may use at least one microphone 30a and at least one speaker 40a of the hands-free conference telephone at the same time, thereby increasing communication quality and convenience.

Referring to FIG. 6C, there is shown a block diagram of the constituent components of a telephone according to an eighth preferred embodiment of the invention. The eighth preferred embodiment substantially has same structure as a combination of the sixth and seventh preferred embodiments (see FIGS. 6A and 6B). The characteristics of the eighth preferred embodiment are detailed below. The transmitter 3 comprises a microphone 3a and the receiver 4 comprises a speaker 4a of a handset respectively (i.e., configuration I). The transmitter 3 further comprises at least one microphone 3a and the receiver 4 further is implemented as at least one speaker 40a of a hands-free conference telephone respectively (i.e., configuration II). In installation configuration I and/or configuration II can be implemented on a telephone, thereby increasing communication quality, being more selective, increasing convenience, and totally utilizing the powerful functions of a telephone.

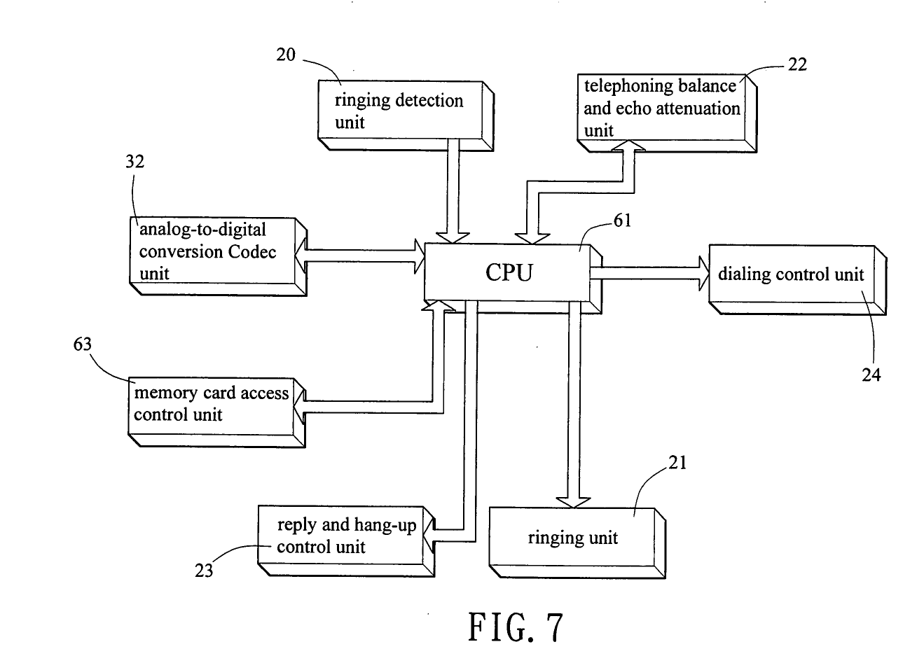

FIG. 7 is a block diagram of the constituent components of main controller 6 according to a first preferred embodiment of main controller of the invention. The main controller 6 comprises a ringing detection unit 20, a ringing unit 21, a telephoning balance and echo attenuation unit 22, a reply and hang-up control unit 23, a dialing control unit 24, an analog-digital conversion Codec (coder/decoder) unit 32, a CPU 61, and a memory card access control unit 63. The ringing detection unit 20 is adapted to detect the ringing signal of an incoming call. The ringing signal can be a typical high voltage ringing having 75V rms and 16 to 20 Hz or a ringing signal carried on the telephone line. The ringing unit 21 is adapted to generate a ringing signal to ring the telephone. The telephoning balance and echo attenuation unit 22 is adapted to maintain an impedance matching between a telephone network and a transmitter or a receiver of a hands-free handset, and attenuate echo caused by the telephone line and the environment for ensuring a good communication quality. The reply and hang-up control unit 23 is adapted to detect an on-hook or off-hook signal transmitted from a handset or a keypad of a telephone. The dialing control unit 24 is adapted to receive input signal from a keypad and thus generate a correct dialing signal, instruction, data (e.g., DTMF (dual tone modulation frequency) dialing pulse), or a dialing of a predetermined instruction or data generated by a digital telephone line prior to sending to the telephone line. The analog-digital conversion Codec unit 32 is adapted to convert an analog signal from a telephone line, transmitter, or microphone into a digital signal which is then sent to the CPU 61 for processing. Alternatively, the analog-digital conversion Codec unit 32 is adapted to convert the processed audio digital signal into an analog signal which is then sent to a receiver, a speaker for broadcasting, or an analog telephone line. The CPU 61 is adapted to control the operations of other components. The operations comprise signal detection, monitoring, compression of image and data, format conversion, and I/O. The CPU downloads programming codes from the memory card and then identifies the codes as execution file, text file, audio file, image file, instruction, or data file. The CPU 61 is adapted to automatically activate a downloaded program to perform the same or as instructed by a user so that one of various functions of the telephone can be performed. The internal execution programs are preprogrammed as programs having a specific function before being delivered from the factory. Alternatively, one of a plurality of predetermined functions of the CPU 61 can be created by linking applications of the inserted memory card or replaced by a desired application such that one of various functions of the telephone can be performed. The memory card access control unit 63 is controlled by the CPU 61 and is adapted to download data from the memory card or upload data therefrom. By cooperating with other components described above, the main controller 6 is thus able to control a telephone and access programs or data from the inserted memory card, thereby enabling the telephone to use as a multifunctional telephone for being adapted to different applications, purposes, or usage.

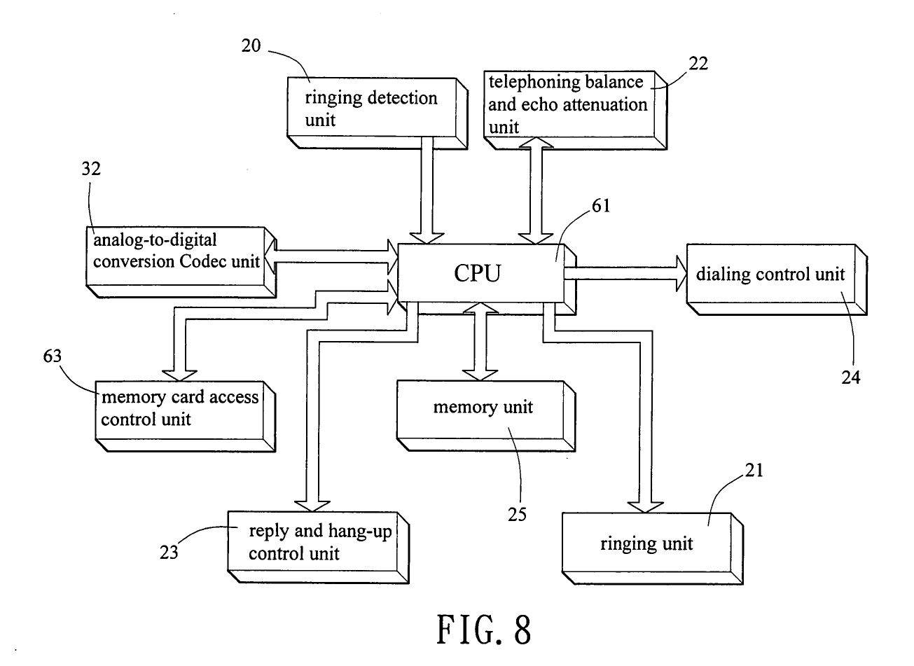

FIG. 8 is a block diagram of the constituent components of main controller 6 according to a second preferred embodiment of main controller mounted in a telephone having a slot for receiving a removable memory card according to the invention. The second preferred embodiment of the main controller substantially has same structure as the first preferred embodiment thereof. The characteristics of the second preferred embodiment of the main controller are detailed below. The main controller 6 further comprises a memory unit 25, served as a memory, for providing a program storage required by the CPU 61, for facilitating CPU operation, and for ease of uploading or downloading data with respect to the memory card.

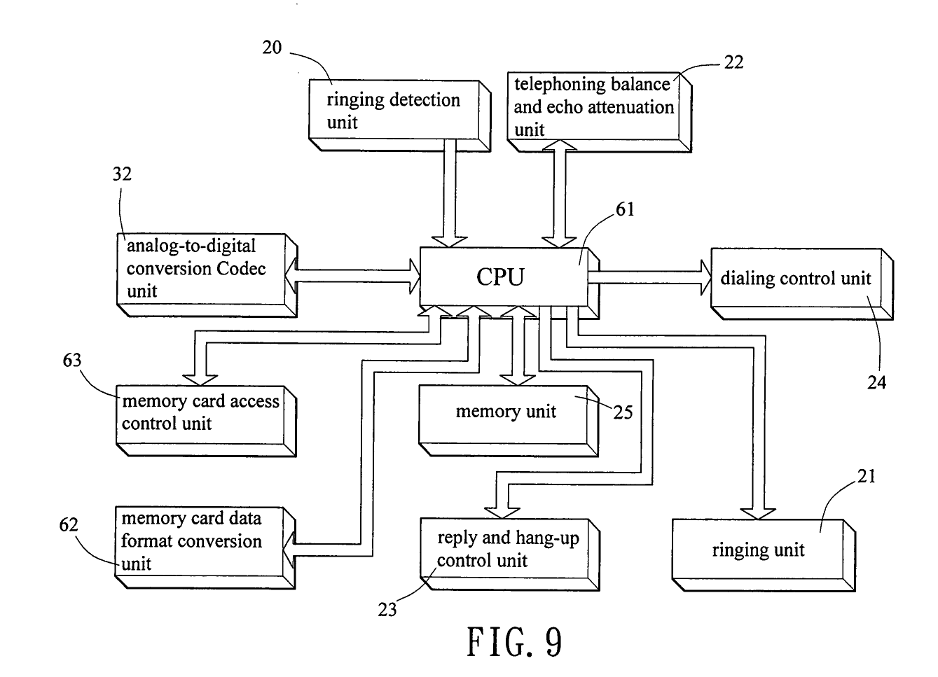

FIG. 9 is a block diagram of the constituent components of main controller 6 according to a third preferred embodiment of main controller mounted in a telephone having a slot for receiving a removable memory card according to the invention. The characteristics of the third preferred embodiment of the main controller are detailed below. The main controller 6 further comprises a memory card data format conversion unit 62 for either reading data having one format from the CPU 61 prior to converting it into data having another format compatible with a computer or writing data having another format from the computer into the CPU 61 such that user convenience can be increased.

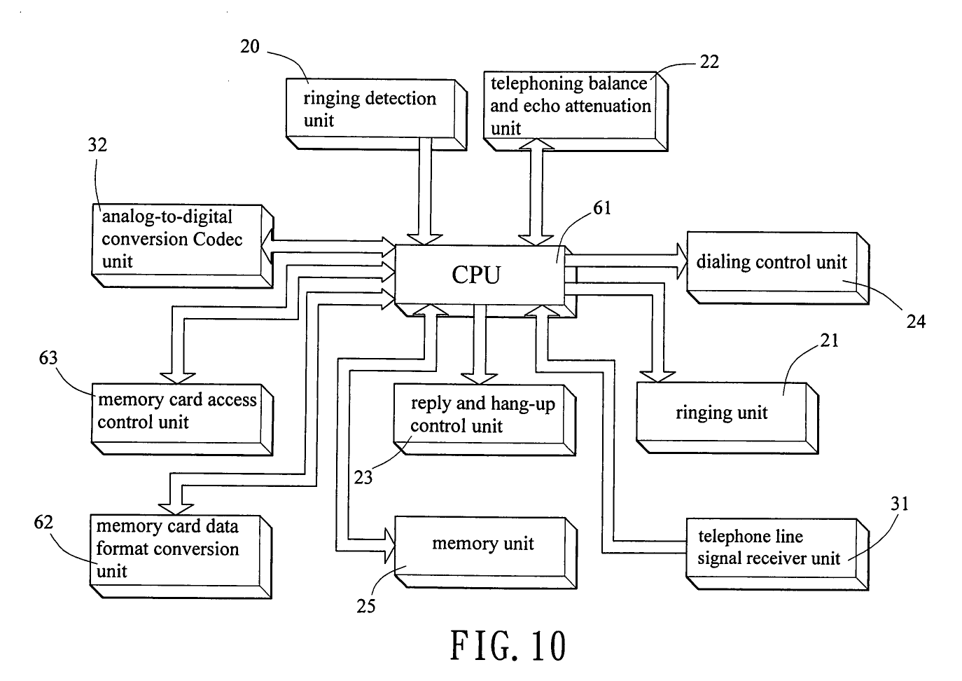

FIG. 10 is a block diagram of the constituent components of main controller 6 according to a fourth preferred embodiment of main controller mounted in a telephone having a slot for receiving a removable memory card according to the invention. The characteristics of the fourth preferred embodiment of the main controller are detailed below. The main controller 6 further comprises a telephone line signal receiver unit 31 for receiving signals from a telephone line. These signals comprise DTMF, caller ID, and one of voice, busy, ringing, polarity inversion, etc. The predetermined codes, instructions, data, or the like from a telephone line can be read by the unit 31.

As shown in FIGS. 7 to 10, the ringing detection unit 20, the ringing unit 21, the telephoning balance and echo attenuation unit 22, the reply and hang-up control unit 23, and the dialing control unit 24 are components of a well known telephone. Alternatively, the CPU 61, the memory card access control unit 63, the memory unit 25, the memory card data format conversion unit 62, and the telephone line signal receiver unit 31 can be incorporated into a well known telephone respectively in any of other embodiments of the invention.

The semiconductor industry and software technology are advanced rapidly and DSPs (digital signal processors) are more powerful and convenient. As such, components of the main controller 6 of the invention can be implemented as hardware, software, or a combination thereof. Two or more components of the main controller 6 can be combined as a unit or each component of the main controller 6 can be comprised of a plurality of sub-units. The main controller may be implemented as a single IC chip including memory, CPU, or DSP. Also, each unit of the main controller can be implemented as by software or hardware. In application, a user may buy one or more software packages each being adapted to run a specific function of the telephone according to the invention such that the cost of expansion can be reduced.

Different programs or data can be incorporated into the memory card of the invention as stored data by operating a computer or any equivalent measure. Once a memory card is inserted into a receiving slot, the main controller of telephone activates a resident for reading data from the memory card. Thus, programs, audio-video data, or text data stored in a program or data storage of the memory card can be sent to the telephone. Then, the resident runs the read application for performing a desired function of the telephone as required. Alternatively, programs, images, sound, and data including communication data sent over the telephone line can be stored in the memory card for the operation of telephone. Still alternatively, data stored in the memory card can be loaded into a computer for analysis, statistic, broadcasting, displaying, or any specific usage such that the telephone can be configured as a multifunctional telephone for being adapted to different purposes and applications.

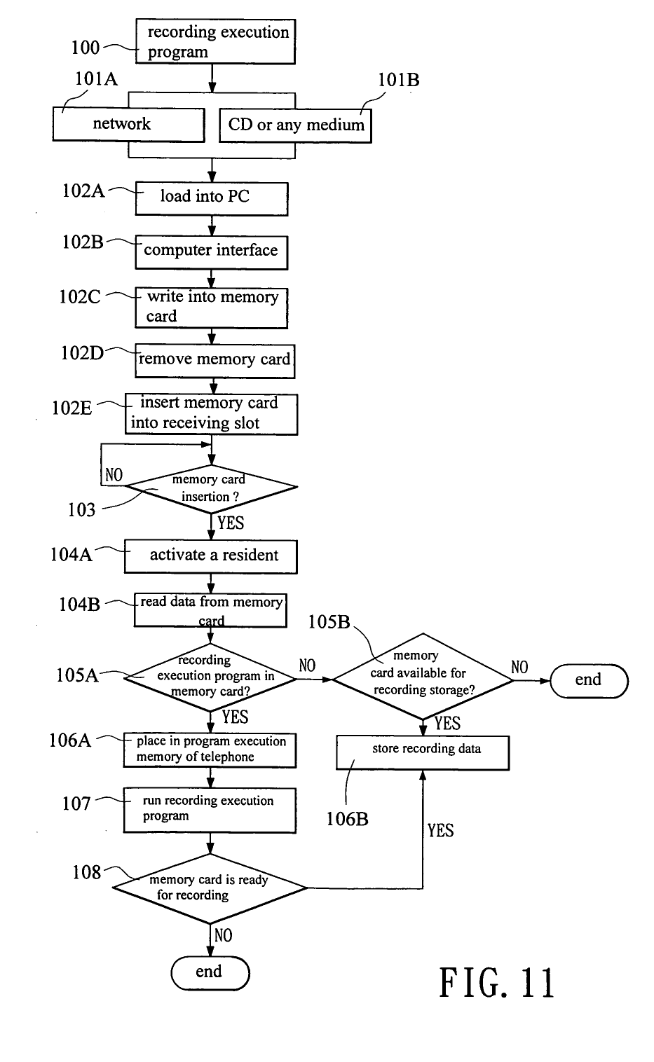

FIG. 11 is a flow chart illustrating processes of memory card insertion and programming according to the invention. In step 100, a recording execution program is ready by a manufacturer. Next, the recording execution program is sent to a network (step 101A) and a CD-ROM or any of other media (step 101B). User loads the recording execution program into a PC (step 102A). The recording execution program is then sent to a computer interface (e.g., USB port, RS232 port, or the like) in step 102B. The recording execution program is then sent to a memory card for writing thereinto from the computer interface (step 102C). In step 102D, a user removes the memory card and then inserts the same in a memory card interface of the telephone (step 102E). The telephone then detects whether the memory card has been inserted into the memory card interface (step 103). If yes, an embedded resident is activated (step 104A) and then reads data from the memory card (step 104B). The resident determines whether this is a recording execution program or not. If yes, place the recording execution program in a program execution memory of the telephone (step 106A). A CPU of the telephone runs the recording execution program for configuring the telephone as a special telephone having a recording feature (step 107). The process goes to step 105B if there is no recording execution program in the memory card as determined in step 105A. In step 105B, the resident determines whether data contained in the memory card is available for recording storage (step 105B). If yes, call recording of the telephone will be stored in the memory card, i.e., recording data being stored in the memory card (step 106B). The memory card can be implemented as a data storage card for recording a call or signal data of the operation. As the process goes to step 108 from step 107, it is determined whether the memory card is ready for recording or not. If yes, the process jumps to step 106B. Otherwise, the process ends. In such a manner, data contained in the memory card can be either programmed as a program for performing a specific function. Alternatively, the memory card is used as a data storage card only. The function program can be installed in a telephone before delivery such that a user may buy a telephone having such specific function. Further, a user may replace a memory card with a new one having one or more newly developed functions such that data (e.g., sound, dialing, or defined data, texts, images, signals, or the like) created in a call can be stored in the memory card for either repeatedly playing, displaying, and analysis or being sent to a computer via a computer interface for other purposes.

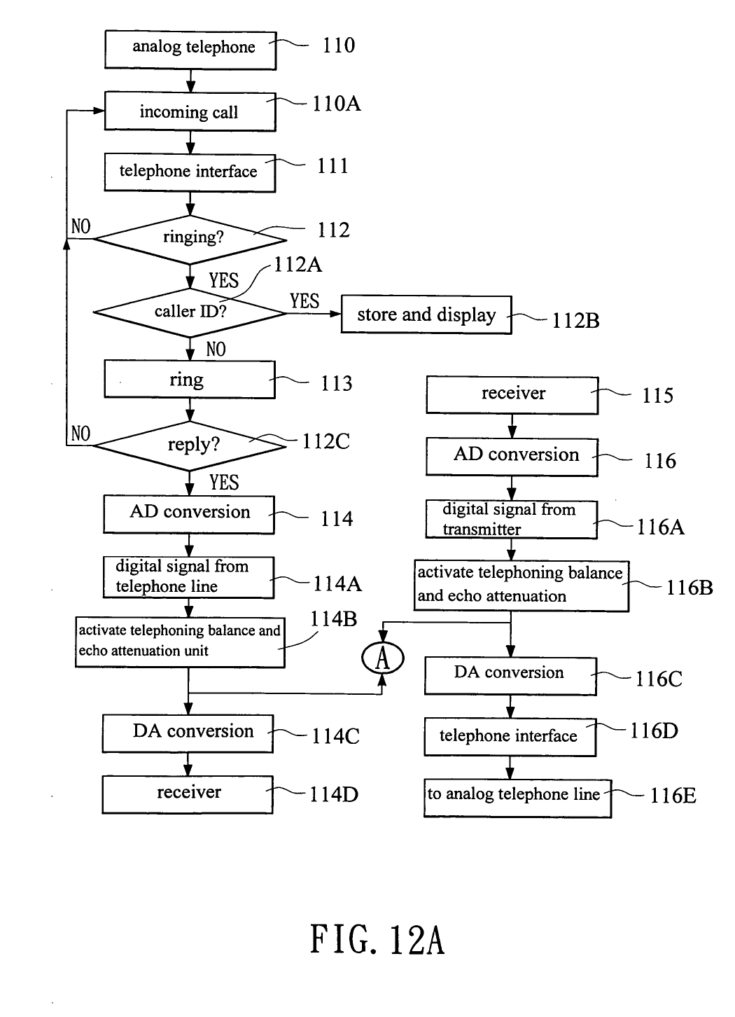

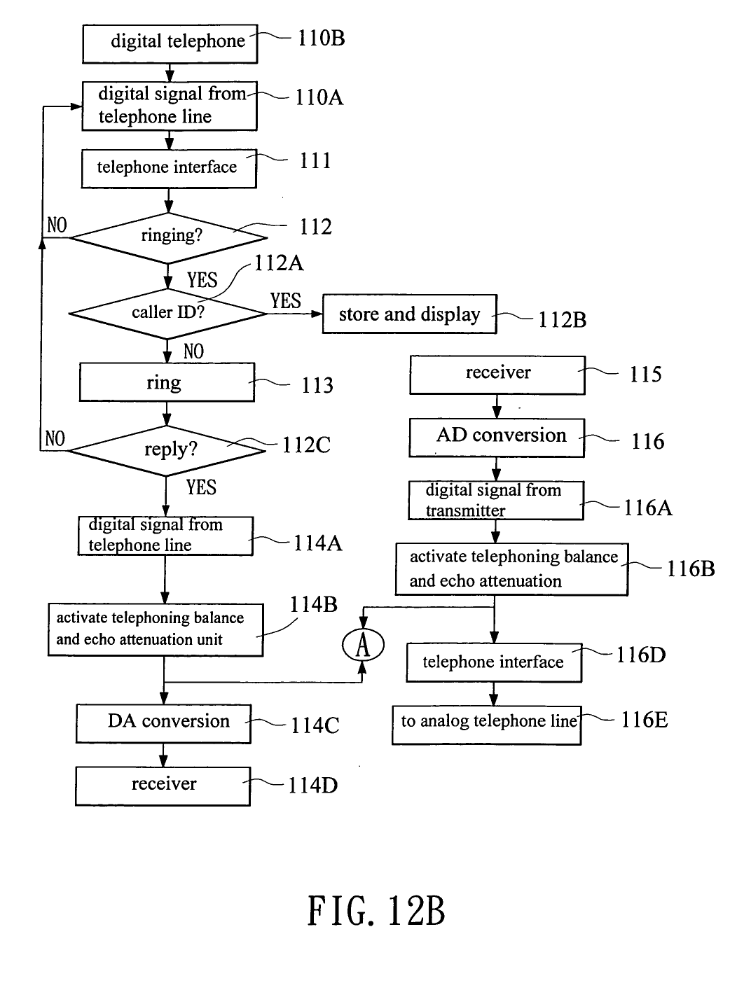

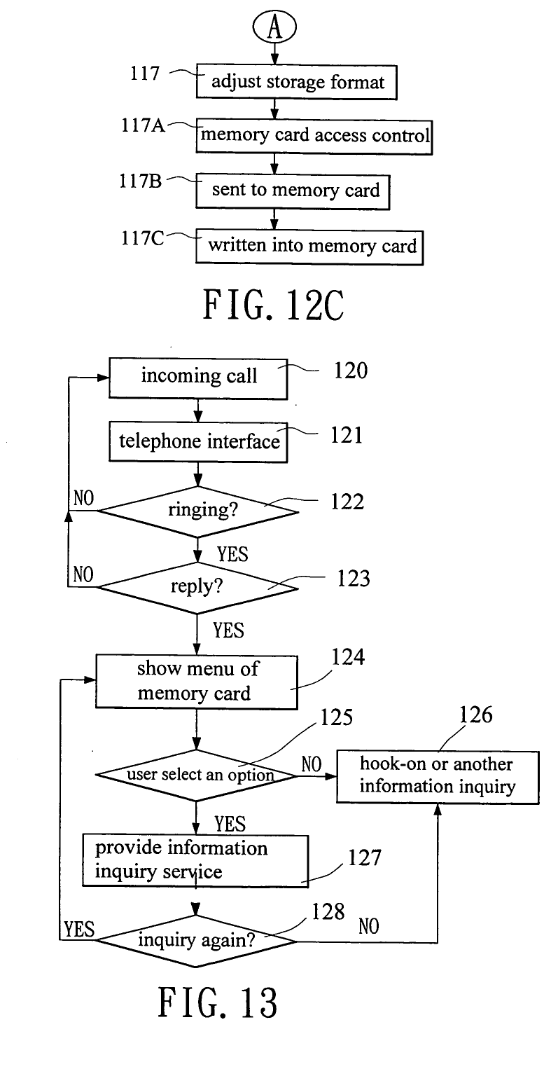

FIGS. 12A, 12B, and 12C are flow charts illustrating a process of call recording according to the invention in which FIG. 12A illustrates an analog telephone flow chart, FIG. 12B illustrates a digital telephone flow chart, and FIG. 12C illustrates a memory card storage flow chart. In the illustration of FIG. 12A, for an analog telephone (step 110) an incoming call is detected (step 110A) and is sent to a telephone interface (step 111). In step 112, it is determined whether a ringing a generated in response to the call. If yes, it is determined whether the ringing contains the caller ID (i.e., telephone number) (step 112A). If yes, the process goes to step 112B for storage and display. If not, ringing is generated (step 113). It is determined whether a reply has been issued (step 112C). If yes, sound and signals conveyed on the telephone line are sent to the analog-digital conversion Codec unit 32 for converting into digital signals (step 114). The digital signals are then compressed and converted by running software as required. At this time, receiver is enabled (step 115) to send sound to the analog-digital conversion Codec unit 32 for converting into digital signals (step 116). There are two sources of digital signal in which one is from a telephone line and the other is from a transmitter and has been processed by running software by CPU (steps 114A and 116A) (i.e., digital format processing). In steps 114B and 116B, the telephoning balance and echo attenuation unit 22 is activated to attenuate echo. Next, they are sent to analog-digital conversion Codec unit 32 for converting the digital signals into analog signals (steps 114C and 116C). Next, they are sent to the receiver (step 114D) for receiving and to a telephone line (step 116E) via a telephone interface (step 116D).

FIG. 12B illustrates a digital telephone flow chart. In the illustration of FIG. 12B, the signal is already a digital one. Further, analog signals from the transmitter have been converted into digital signals. The digital signal sent over the digital telephone line is adapted to process with respect to an audio format and conversion as required such that as long as it complies with the specifications of a digital telephone line in which a CODEC conversion is not required. These are the only differences between digital and analog telephone lines. Other steps shown in FIG. 12B are the same as that shown in FIG. 12A and are labeled in the same reference numerals. Thus, a detailed description is omitted herein for the sake of brevity.

FIG. 12C illustrates a data writing process of the memory card of the invention. The characteristics of the invention are detailed below. The converted different digital signals of the above call are adjusted with respect to the storage format based on the required format of computer so as to be compatible with a playing or reading format of computer (step 117). Next, the memory card access control unit 63 is enabled in step 117A and thus data or programs are sent to the memory card for writing thereinto via a receiving slot interface (steps 117B and 117C). This completes the recording process. Alternatively, data contained in the memory card can be read by software installed in the CPU of telephone. Next, a conversion is done so that an operation of the keypad or display of a telephone may cause the receiver to broadcast or cause the display to show.

FIG. 13 is a flow chart illustrating a process of information inquiry (i.e., for providing information inquiry service) according to the invention. The process comprises the following steps. Place a memory card having required information in a telephone prior to detecting an incoming call (step 120) and sending to a telephone interface (step 121). In step 122, it is determined whether a ringing a generated in response to the call. If yes, it is determined whether a reply has been issued (step 123). That is, the telephone will go to step 123 automatically for answering if there is no reply from the telephone. In step 224, a prerecorded menu of the memory card is shown for guiding a user to enter into step 125 so that the user may select a desired option of the menu for obtaining inquired information. When employees are not available, the process can automatically goes to step 127 for providing information inquiry service. That is, after leaving the menu selection and going to step 125, the process either goes to step 126 for performing a hook-on or another information inquiry if the selected option is not an information inquiry or goes to step 128 for inquiring again if the selected option is an information inquiry. If the inquiry is positive, the process loops back to step 124. Otherwise, the process goes to step 126 for performing a hook-on or another information inquiry. The process has the same features as that of the analog and digital telephone line and the same features as that of the analog-digital conversion Codec unit 32 (see FIG. 11). Thus, a detailed description is omitted herein for the sake of brevity.

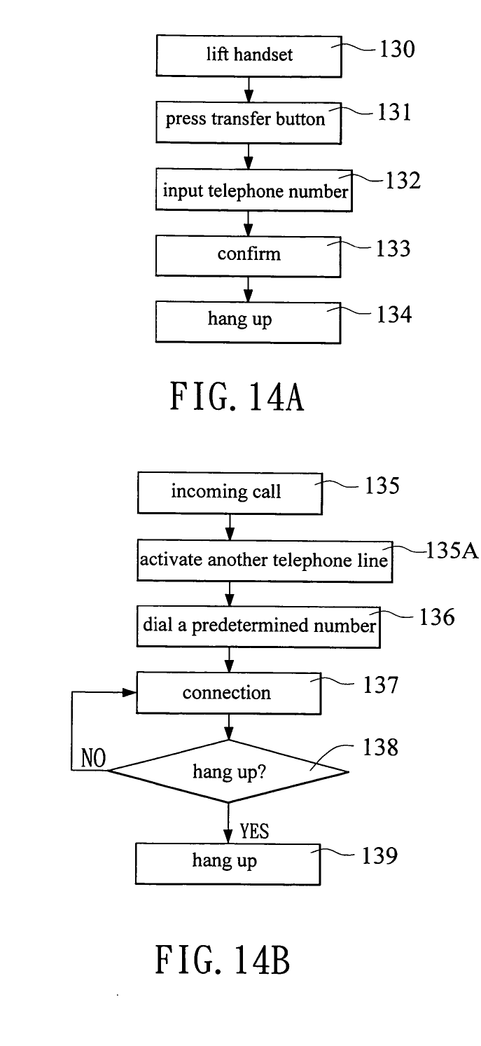

FIGS. 14A and 14B are flow charts illustrating a process of transfer according to the invention in which FIG. 14A illustrate a process of transfer setting and FIG. 14B illustrate a process of transfer programming respectively. In FIG. 14A, an illustration of a process of transfer setting is detailed. The process comprises step 130 of lifting a handset, step 131 of pressing a transfer button of the keypad, step 132 of inputting a telephone number by mean of telephone, step 133 of confirming the same, and step 134 of hanging up for ending the transfer after determining the confirmation to be correct.

In FIG. 14B, an illustration of a process of transfer programming is detailed. The process comprises step 135 of detecting an incoming call, step 135A of activating another telephone line, step 136 of sending a dialed predetermined telephone number, step 137 of connecting two telephone lines together, step 138 of determining whether the telephone has been hanged up, and step 139 of hanging up the telephone if the determination in the step 138 is positive. Note that if the determination in the step 138 is negative the process will loop back to step 137 for continuing the connection attempt. In such a manner, a telephone enables the telephone immediately in response to running a telephone transfer program by the telephone. A user may input the transferred telephone number by means of telephone. Then the incoming call will be transferred to another location by another telephone line if there is no reply from the called party. As an end, a telephone connection is done. The process has the same features as that of the analog and digital telephone line and the same features as that of the analog-digital conversion Codec unit 32. Thus, a detailed description is omitted herein for the sake of brevity.

In view of the above, the most important characteristics of the invention is that the removable memory card is adapted to insert into a receiving slot of cordless telephone, network telephone, telephone attached to a call answering device, duplex telephone, telephone having a hands-free handset, conference telephone, image telephone, or the like produced by different manufacturers such that the telephone can be more made powerful. Also, an update of software installed in the telephone can improve the performance of the telephone. Alternatively, the removable memory card of the invention can be used as a data storage such that data created in the communication can be stored in the memory card and then be stored in the computer for further display, copying, analysis, statistics, listing, and storage. As a result, the benefits of the invention are significant.

In view of the above, the benefits of this invention include: (1) combining a computer and a telephone line for increasing performance of the telephone; (2) increasing the functions of telephone by inserting a memory card having one or more software packages installed therein so that a single telephone can perform any of other functions not provided by telephone hardware in addition to voice communication; (3) enabling vast consumers to buy a telephone having almost unlimited expansion capabilities; and (4) enabling a telephone connected to the telephone line to perform any of installed software packages, i.e., the applications being diversified.

As stated above, the invention is applicable to cordless telephone, network telephone, telephone attached to a call answering device, duplex telephone, telephone having a hands-free handset, conference telephone, image telephone, or the like produced by different manufacturers by inserting the removable memory card into a receiving slot thereof such that the telephone can be made more powerful. Also, an update of software installed in the telephone can improve the performance of the telephone. Alternatively, the removable memory card of the invention can be used as a data storage such that data created in the communication can be stored in the memory card and then be stored in the computer for further display, copying, analysis, statistics, listing, and storage. As a result, the benefits of the invention are significant.

While the invention herein disclosed has been described by means of specific embodiments, numerous modifications and variations could be made thereto by those skilled in the art without departing from the scope and spirit of the invention set forth in the claims.

1. A telephone comprising:
an internal main controller including a CPU and a DSP;
a receiving slot provided on a housing of the telephone and being adapted to removably receive memory card means; and
a removable memory card being adapted to either insert into the receiving slot or remove therefrom;
wherein the memory card is a readable/writable memory card and is adapted to connect to a computer via one of a plurality of interfaces including USB port, a RS232 port, or a network such that a plurality of programs or data downloaded from the network or the computer can be stored in the memory card and after inserting the memory card into the receiving slot, the internal CPU and DSP are adapted to read and run the programs or data to configure the telephone as a multifunctional one.

2. The telephone of claim 1, further comprising a keypad, a transmitter, a receiver, a ringing unit, and a memory card access control unit inside the main controller.

3. The telephone of claim 2, further comprising a display.

4. The telephone of claim 2, further comprising a telephone interface disposed between the main controller and a PSTN or PABX for interconnecting both so as to either send an analog or digital signal to the main controller or receive the same from the main controller.

5. The telephone of claim 2, further comprising a network telephone interface disposed between the main controller and a network side for interconnecting both so as to either send an analog or digital signal to the main controller or receive the same from the main controller.

6. The telephone of claim 2, wherein the transmitter is comprised of at least one microphone, the receiver is comprised of at least one speaker, and the transmitter and the receiver are formed as a unitary handset of hands-free conference telephone.

7. The telephone of claim 2, wherein the transmitter is disposed in a handset of a telephone set and is comprised of at least one microphone, the receiver is disposed in the handset of the telephone set and is comprised of at least one speaker, and the transmitter and the receiver are formed as a unitary handset of hands-free conference telephone.

8. The telephone of claim 2, wherein the main controller comprises a ringing detection unit, a ringing unit, a telephoning balance and echo attenuation unit, a dialing control unit, a reply and hang-up control unit, an analog-digital conversion Codec unit, a CPU including a DSP, a memory unit, and a memory card access control unit such that the main controller is adapted to dispose in the memory card containing different data sources.

9. The telephone of claim 8, wherein the main controller further comprises a telephone line signal receiver unit.

10. The telephone of claim 2, wherein each component of the main controller can be implemented as hardware, software, or a combination thereof, and two or more components of the main controller can be combined as a unit or each component of the main controller can be comprised of a plurality of sub-units such that each unit can be implemented as a single IC chip formed by one of a plurality of semiconductor manufacturing processes wherein the IC chip comprises the CPU or the DSP.

11. A telephone comprising:
an internal main controller including a memory card access control unit;
a receiving slot provided on a housing of the telephone and being adapted to removably receive memory card means; and
a removable memory card being adapted to either insert into the receiving slot or remove therefrom;
wherein the memory card is a readable/writable memory card and is adapted to, as controlled by the main controller, store sound, images, an incoming call, a dialed number, and different data sources sent over a telephone line into the memory card such that the telephone or another telephone can read and use the same or send into a computer via a computer interface thereof, and a program performs analysis, statistics, display, playing, storage, and printing with respect to contents of the memory car, and uses it.

12. The telephone of claim 11, further comprising a keypad, a transmitter, a receiver, and a ringing unit.

13. The telephone of claim 11, wherein the main controller comprises a ringing detection unit, a ringing unit, a telephoning balance and echo attenuation unit, a dialing control unit, a reply and hang-up control unit, an analog-digital conversion Codec unit, a CPU including a DSP, a memory unit, and a memory card access control unit such that the main controller is adapted to dispose in the memory card containing different data sources.

14. The telephone of claim 11, further comprising a telephone interface disposed between the main controller and a PSTN or PABX for interconnecting both so as to either send an analog or digital signal to the main controller or receive the same from the main controller.

15. The telephone of claim 11, further comprising a network telephone interface disposed between the main controller and a network side for interconnecting both so as to either send an analog or digital signal to the main controller or receive the same from the main controller.

16. The telephone of claim 11, wherein the transmitter is comprised of at least one microphone, the receiver is comprised of at least one speaker, and the transmitter and the receiver are formed as a unitary handset of hands-free conference telephone.

17. The telephone of claim 11, wherein the transmitter is disposed in a handset of a telephone set and is comprised of at least one microphone, the receiver is disposed in the handset of the telephone set and is comprised of at least one speaker, and the transmitter and the receiver are formed as a unitary handset of hands-free conference telephone.

18. The telephone of claim 11, wherein the main controller further comprises a telephone line signal receiver unit.

19. The telephone of claim 12, further comprising a display.
